(19) United States
(12) Patent Application Publication
(10) Pub. No.: US 2013/0209751 A1
(43) Pub. Date: Aug. 15, 2013

(54) ALKALI ALUMINOSILICATE GLASS FOR 3D PRECISION MOLDING AND THERMAL BENDING

(71) Applicants: Guangjun Zhang, Jiangsu (CN); José Zimmer, Losheim Am See (DE); He Feng, Jiangsu (CN); Gerhard Lautenschlaeger, Jena (DE); Armin Vogl, Jena (DE)

(72) Inventors: Guangjun Zhang, Jiangsu (CN); José Zimmer, Losheim Am See (DE); He Feng, Jiangsu (CN); Gerhard Lautenschlaeger, Jena (DE); Armin Vogl, Jena (DE)

(73) Assignee: SCHOTT GLASS TECHNOLOGIES (SUZHOU) CO. LTD., Suzhou, Jiangsu (CN)

(21) Appl. No.: 13/698,728

(22) PCT Filed: May 18, 2011
(86) PCT No.: PCT/CN11/74226

§ 371 Date: Feb. 4, 2013

(30) Foreign Application Priority Data
May 18, 2010 (CN) 201010183668.6

(51) Int. Cl. C03C 3/112

(52) U.S. Cl. CPC C03C 3/112
USPC 428/174; 428/410; 501/57

(57) ABSTRACT

An alkali aluminosilicate glass for 3D precision molding and thermal bending is provided. The glass has a working point lower than 1200° C. (10⁴ dPas) and a transition temperature T_{g} lower than 610° C. The glass has, based on a sum of all the components in percentage by weight, 51-63% of Si0₂; 5-18% of Al₂0₃; 8-16% of Na₂0; 0-6% of K₂0; 3.5-10% of MgO; 0-5% of B₂0₃; 0-4.5% of Li₂0; 0-5% of ZnO; 0-8% of CaO; 0.1-2.5% of Zr0₂; 0.01-<0.2% of Ce0₂; 0-0.5% of F₂; 0.01-0.5% of Sn0₂; 0-3% of BaO; 0-3% of SrO; 0-0.5% of Yb₂0₃; wherein the sum of Si0₂+Al₂0₃ is 63-81%, and the sum of CaO+MgO is 3.5-18%, and the ratio of Na₂0/(Li₂0+Na₂0+K₂0) is 0.4-1.5.

### TECHNICAL FIELD

The present invention generally relates to a glass composition, the present invention further relates to an alkali aluminosilicate glass having relatively lower working point, good melting property, low transition temperature as well as good ion exchange capacity and high strength. The glass composition can be used for 3D precision molding and thermal bending and can be cut by laser. At the same time, the present invention relates to a preform composed of the above glass composition for precision molding and a method for preparing the same, and a corresponding optical element and a process for preparing the same.

### BACKGROUND

A cover glass is generally used in electronic devices, portable electronic devices, such as personal digital assistants, portable or cellular cells, watches, laptops and notebook PCs, digital cameras, PDAs, or as a substrate glass for touch panels. In some applications, the cover glass is sensitive to users' touching and prone to being damaged, scraped and deformed. Since such frequent touch, the cover glass should have high strength and is scrape resistant. Traditional soda-lime glass cannot satisfy the requirements in this respect, such as high strength and scrape resistance. An alkali aluminosilicate glass, which has high strength, high hardness, stable chemical resistance, low coefficient of thermal expansion, high scrape resistance and high impact, can be suitably used as the cover glass of electronic articles, such as personal digital assistants, portable or cellular cells, watches, laptops and notebook PCs, digital cameras, PDAs, or as a substrate glass for touch panels.

The demand for 3D-shaped cover glass is ever increasing recently. The 3D-shaped cover glass and touch panel glass can have different shapes, such as a plate, an arc, a bent plane and an edgefold, and the 3D-shaped cover glass and touch panel glass can be re-processed, such as patterning, drilling, etc. on the glass.

The 3D-shaped cover glass can be used on the front-side and back-side of a device. When used in the back-side, additional decorations can be applied through screen printing process with organic or inorganic pigments, however, decorations can also be applied to the inside or outside of the cover glass.

Economic processes for preparing the 3D-shaped cover glass are processes, such as 3D precision molding or thermal bending.

A mold plays a very important role in 3D molding. The lifetime of a mold will greatly influence profitability of finished molding articles and/or materials. As for a long lifetime of a mold, a very important factor for the mold is to have an operational temperature as low as possible, however, the temperature can only be lowered to such a point that under said temperature, the viscosity of the material to be compressed is still sufficient for a pressing step, which means that there is a direct causal relation between the processing temperature and the profitability of the pressing step, thus in turn between the transition temperature T_{g} of the glass and the profitability of the pressing step.

If necessary, the mold and the preform are subjected to coating treatment.

For the purpose of production at a lower cost and in a large scale through precision molding, the mould for precision molding is supposed to be used repeatedly. To this end, the temperature during precision molding should be as low as possible to minimize oxidization on the surface of the mold by use of a glass having a suitable softening property, i.e., having a suitable glass transition temperature T_{g}.

The precision molding comprises heating a preform made of flat glass to softening, and then pressing in a mold with precision surface. The important feature of the method is the omission of grinding or polishing the cover glass after being molded, thereby producing the cover glass at a lower cost and in a large scale.

Besides precision molding, thermal bending can also be used for glass molding, which can either be partially facilitated by use of pressure or vacuum or can be carried out by infrared heating. Upon heating, the glass will deform rapidly under the action of its own gravity. The deformation of the glass does not stop until each part of the surface of the glass contacts the surface of the support under the glass, or the glass bends along the edge of the support till the surface is perpendicular to the ground. Glass cover-plates having 2D or 3D shapes can be produced by thermal bending via producing moulds of different shapes as supports.

For all the molding technologies, what is important is that the glass surface is not sensitive to generation of surface defects during heat processing.

The cover glass generally needs to undergo chemical toughening. The chemical toughening can enhance strength of the glass, thereby withstanding scrape and impact to avoid cracking. The chemical toughening is to form surface compressive stress of the glass through ion exchange. A simple principle of an ion exchange process is that ions having smaller radius in the surface of the glass exchange with ions having larger radius in liquid in a salt solution at a temperature of 350-490°, for example, sodium ions in the glass exchange with potassium ions in a solution, generating surface compressive stress due to differences in volumes of alkali ions. This process is particularly suitable for a glass having a thickness of 0.5-4 mm. The advantages of chemical toughening of glass include no glass warpage, the same surface flatness as the original glass sheet, an improved strength and temperature change resistance, and being suitable for cutting treatment. By controlling DoL (Depth of Surface Stress Layer) and surface compressive stress reasonably, a glass having a relatively stronger strength can be obtained. Values of DoL and surface compressive stress are related to the components of the glass, particularly to the amount of alkali metals in the glass, and also related to the glass toughening processes including time and temperature for toughening. During chemical toughening, a compressive stress layer will form on the glass surface, and the depth of the compressive stress layer is in direct proportion to the square root of the chemical toughening time according to the ion-dispersion principle. The longer the chemical toughening time is, the deeper the toughening layer is, the smaller the surface compressive stress is, the larger the central tensile stress is. When the time of chemical toughening is too long, the strength of the glass will decrease due to reduced surface compressive stress caused by an increasing central tensile stress and a loosened glass structure. Therefore, there is an optimal chemical toughening time at which point a balance among the surface compressive stress, the depth of the toughening layer and the central compressive stress is achieved, whereby a glass having the optimized strength can be acquired. The optimal chemical toughening time varies depending on the components of the glass, the components of the salt bath and the toughening temperature.

U.S. Patent application US2008/286548 describes an alkali aluminosilicate glass having high mechanical property. However, the glass has a high softening point and therefore, is not suitable for precision molding or thermal bending. The glass comprises an amount of SiO₂ higher than 64 wt. %, which causes the melting temperature to go up and increases the viscosity and numbers of bubbles in the glass. In addition, the glass comprises MgO of lower than 6 wt. % and CaO of lower than 4 wt. %, resulting in difficulties in lowering the working point of the glass effectively, and thus it is hard to process the glass. Therefore, the glass is not suitable to precision molding or thermal bending.

Chinese patent applications 200910086806, 200810147442 and 200910301240 disclose an alkali aluminosilicate glass, which comprises MgO lower than 6 wt. % and CaO lower than 4 wt. %. Such concentration levels cannot lower the working point of the glass effectively. Therefore, it is difficult to manufacture the glass. The glass is not suitable to precision molding or thermal bending as having a high T_{g}.

The alkali aluminosilicate glass currently used for producing a cover plate has problems of a high melting temperature and a large viscosity at high temperature, thereby making the melting process of the glass complicated and uncontrollable. Moreover, inner bubbles cannot be removed easily. Beyond that, high melting temperatures reduce the lifetime of refractory material of the melting furnace and in turn lead to a higher production cost.

In addition, the alkali aluminosilicate glass currently used for production of a cover plate has a high working point normally higher than 1250° C. (10⁴ dPas), which increases difficulties in melting and molding. Lowering the working point may result in a decreased glass melting temperature at the same time.

Aiming at the above problems, the alkali aluminosilicate glass has been successfully developed in the present invention, which lowers the working point temperature of the alkali aluminosilicate glass by adjusting components of the glass without damaging mechanical properties of the glass, achieving the purpose of reducing the molding temperature of the glass and lowering production cost. Lowering of the working point becomes very important for achieving the purpose of producing the glass at a lower cost and with an easier procedure. The so-called “working point” refers to the temperature at a viscosity of 10⁴ dPas, at which point, the glass is sufficiently soft so as to be molded in a glass molding process, such as blowing or pressing.

### SUMMARY OF THE INVENTION

The object of the present invention is to provide an alkali aluminosilicate glass suitable for chemical toughening having a relatively low viscosity at high temperature, a low working point, a low transition temperature, a good meting property as well as a good ion exchange capacity, and the glass has high strength, high chemical stability and high hardness. The glass has low evaporation of components during melting, pressing and thermal bending, and good processability for 3D precision molding and thermal bending, and can be cut by laser. The glass of the present invention has higher amounts of MgO and CaO, which can be adjusted to lower the working point and improve the melting property of the glass. The present invention has an optimized Na₂O/(Li₂O+Na₂O+K₂O) ratio of 0.4-1.5. The glass with said optimized Na₂O/(Li₂O+Na₂O+K₂O) ratio has a low transition temperature and good matching between the DoL (the depth of the layer of surface compressive stress) and the surface compressive stress after being toughened, which in turn further enhance the strength of the glass. During 3D precision molding and thermal bending, it is very important to maintain a minimum evaporation of glass components. The alkali metal normally tends to evaporate. The evaporation of glass components will change the components of the glass and further the evaporated components can react with the mold of precision molding or thermal bending. The glass can have less evaporation through a mixed alkali effect by adjusting and optimizing the amounts of alkali metals and, which will reduce the reaction between the glass and the mold, whereby the accuracy of the glass components after high precision compression or thermal bending can be maintained.

The ion exchange can be carried out for the purpose of chemical toughening of the glass before or after thermal bending of the alkali aluminosilicate glass of the present invention.

The above purposes of the present invention are achieved through the following technical solutions:

One aspect of the present invention is to provide an alkali aluminosilicate glass for 3D precision molding and thermal bending, said glass comprises, based on the sum of all the components:

| Components | wt. % |
|---|---|
| SiO₂ | 51-63% |
| Al₂O₃ | 5-18% |
| Na₂O | 8-16% |
| K₂O | 0-6% |
| MgO | 3.5-10% |
| B₂O₃ | 0-5% |
| Li₂O | 0-4.5% |
| ZnO | 0-5% |
| CaO | 0-8% |
| ZrO₂ | 0.1-2.5% |
| CeO₂ | 0.01-<0.2% |
| F₂ | 0-0.5% |
| SnO₂ | 0.01-0.5% |
| BaO | 0-3% |
| SrO | 0-3% |
| Yb₂O₃ | 0-0.5% |
| SiO₂ + Al₂O₃ | 63-81% |
| CaO + MgO | 3.5-18% |
| Na₂O/(Li₂O + Na₂O + K₂O) | 0.4-1.5. |

Another aspect of the present invention is to provide an alkali aluminosilicate glass for 3D precision molding and thermal bending, said glass comprises, based on the sum of all the components:

| Components | wt. % |
|---|---|
| SiO₂ | 53-62 |
| Al₂O₃ | 5-17% |
| Na₂O | 9-15% |
| K₂O | 2-5% |
| MgO | >6 and ≦9% |
| B₂O₃ | 0-3% |
| Li₂O | 0-4% |
| ZnO | 0-5% |
| CaO | >4 and ≦7% |
| ZrO₂ | 0.5-1.8% |
| CeO₂ | 0.01-<0.2% |
| F₂ | 0.1-0.5% |
| SnO₂ | 0.01-0.5% |
| BaO | 0-2% |
| SrO | 0-2% |
| Yb₂O₃ | 0-0.5% |
| SiO₂ + Al₂O₃ | 66-79% |
| CaO + MgO | >10 and ≦18 wt. % |
| Na₂O/(Li₂O + Na₂O + K₂O) | 0.5-1. |

A further aspect of the present invention is to provide an alkali aluminosilicate glass for 3D precision molding and thermal bending, said glass comprises, based on the sum of all the components:

| components | wt. % |
|---|---|
| SiO₂ | 53-62 |
| Al₂O₃ | 13-17% |
| Na₂O | 9-13% |
| K₂O | 2-5% |
| MgO | >6 and ≦9% |
| B₂O₃ | 0-3% |
| Li₂O | 0-3.5% |
| ZnO | 0-5% |
| CaO | >4 and ≦7% |
| ZrO₂ | 0.5-1.8% |
| CeO₂ | 0.01-<0.2% |
| F₂ | 0.1-0.5% |
| SnO₂ | 0.01-0.5% |
| BaO | 0-2% |
| SrO | 0-2% |
| Yb₂O₃ | 0-0.3% |
| SiO₂ + Al₂O₃ | 66-79% |
| CaO + MgO | >10 and ≦18 wt. % |
| Na₂O/(Li₂O + Na₂O + K₂O) | 0.55-0.9. |

Another aspect of the present invention provides a glass article, wherein the glass article is made of an alkali aluminosilicate glass of the present invention for 3D precision molding and thermal bending.

The glass article of the present invention is characterized in that the article is used as a cover plate of portable electronic devices, and a back plate of handhold devices or laptops.

An additional aspect of the present invention is to provide a glass preform, which is made of the alkali aluminosilicate glass of the present invention for 3D precision molding and thermal bending.

A further aspect of the present invention is to provide an optical component, which is made of the preform of the present invention through 3D precision molding or thermal bending molding.

Yet another aspect of the present invention is to provide an optical component, wherein said optical component is made of the alkali aluminosilicate glass of the present invention for 3D precision molding and thermal bending.

One more aspect of the present invention is to provide an optical article, which comprises the optical component of the present invention.

### BRIEF DESCRIPTION OF FIGURES

FIG. 1 is an absorption spectrum of the glass doped with Yb₂O₃.

### MODES OF CARRYING OUT THE INVENTION

### Detailed Description of the Invention

The glass of the present invention comprises 51 to less than 63 wt. % of SiO₂. The glass of the present invention comprises at least 51 wt. % of SiO₂ as a glass former, and the amount of SiO₂ is at most 63 wt. %. When the proportion of SiO₂ amounts to greater than 63 wt. %, the transition temperature of the glass will go up to higher than 610° C., and the working point will be reach higher than 1250° C.

The amount of Al₂O₃ is in the range of 5-18 wt. %. Al₂O₃ can increase heat resistance, ion exchange property and young modulus of the glass efficiently. However, when the amount of Al₂O₃ increases, the devitrified crystal normally precipitates in the glass, which further reduces the coefficient of thermal expansion, and then cannot keep the viscosity consistent with that of the surrounding materials. And the viscosity will become higher at high temperature. When the amount of Al₂O₃ decreases to less than 5 wt. %, the young modulus and strength of the glass will become lower. In addition, Al₂O₃ is a key component for preparing a glass of high hardness and high strength. Al₂O₃ in the glass has to be present in such a high amount that a faster dispersion speed can be achieved for the purpose of improving the ion exchange rate of Na⁺—K⁺, since Al³⁺ tends to form a [AlO₄] tetrahedron having a volume much greater than that of a common [SiO₄] tetrahedron in glass, and thus it has a greater space as channels for ion exchange. However, the amount of Al₂O₃ should not be more than 18 wt %, otherwise, the crystallization tendency and viscosity of the glass will increase, which will increase the devitrification probability of the glass, the working point and the melting temperature. Therefore, the amount of Al₂O₃ should be in the range of 5-18 wt. %, better 5-17 wt. %, preferably 13-17 wt. %.

MgO is an important component for lowering the working point of the glass, and thus improving meltability and moldablity of the glass and increasing the strain point and the young modulus. In addition, MgO plays an important role in improving ion exchange property in the components of alkaline-earth metal oxides. The corresponding amount of MgO is 3.5-10 wt. %, preferably >6 but ≦10 wt %.

CaO is also an important component for lowering the working point of the glass, and thus improving meltability and mouldablity of the glass and increasing the strain point and the young modulus. In addition, CaO plays a remarkable part in improving ion exchange property in the components of alkaline-earth metal oxides. However, when the amount of CaO increases, there is a tendency that all the density, the coefficient of thermal expansion and the incidence of cracks increase. As a consequence, the glass tends to devitrify and the ion exchange property tends to deteriorate. Therefore, it is desired that the amount is from 0-8 wt. %, preferably >4 but ≦7 wt %.

Li₂O and ZnO are added to the glass composition of the present invention as the elements of lowering T_{g} of the glass.

Li₂O functions to reduce T_{g} of the glass. Conventional methods for lowering T_{g} of the glass are to add a higher amount of Li₂O, typically more than 5 wt %. However, a higher amount of Li₂O will increase the crystallization tendency and the devitrification probability of the glass. Normally, the glass having a high amount of lithium exhibits higher sensibility to generation of surface defects during heating process. And an excessively high amount of Li₂O will increase the production cost of the glass. The Li₂O is used as a fluxing agent for lowering T_{g} of the glass at a proper amount according to the present invention, according to requirements, of lower than 4.5 wt %, preferably lower than 4 wt %, more preferably lower than 3.5 wt %.

K₂O can lower the viscosity of the glass at high temperature, and therefore increase the meltability and moldablity of the glass, and lower the incidence of cracks. In addition, K₂O is also a component for improving devitrification. K₂O can be present in an amount of 0-6 wt. %, and when higher than 6 wt. %, the devitrification phenomenon intensifies.

Na₂O can lower the viscosity of the glass at high temperature, and therefore the meltability and moldablity of the glass, and lower the incidence of cracks. The glass containing Na₂O can exchange with K⁺, thereby obtaining a high surface stress and then achieving a high efficient exchange. In principle, the amount of Na₂O is desired to be as high as possible, but an excessive amount will increase the crystallization tendency of the glass and deteriorate the devitrification. In the present invention, the amount of Na₂O is 8-16 wt. %, better 9-15 wt. %, preferably 9-13 wt. %.

The ratio of Na₂O/(Li₂O+Na₂O+K₂O) is between 0.4 and 1.5, preferably between 0.5 and 1, more preferably between 0.55 and 0.9. In the above ranges, the glass has a transition temperature of lower than 610° C., preferably lower than 590° C., preferably lower than 570° C., preferably lower than 550° C., and preferably lower than 530° C., which also reduces the evaporation of alkali metals in the process of 3D precision molding and thermal bending, further with the results that an optimized depth of the layer of surface compressive stress DoL and the surface compressive stress are obtained. The depth of the layer of surface compressive stress DoL can be <40 μm, preferably <30 μm, more preferably <20 μm; and the surface compressive stress can be 600-1000 Mpa, preferably 700-1000 Mpa, more preferably 800-1000 Mpa.

ZnO has a function of lowering T_{g} of the glass and improving waterproof. ZnO can have an amount of 0-5 wt. %. If the amount of ZnO is higher than 5 wt. %, devitrification can easily occur in the glass.

SrO and BaO can be introduced to the glass composition of the present invention for different purposes. However, when the amounts of the components are too high, the density and coefficient of thermal expansion will become higher in certain cases, thus the diversity of products is deteriorative with an increased incidence of cracks. And the depth of the layer of compressive stress after ion exchange is becoming shallow, accordingly.

The amount of B₂O₃ is in the range of 0-5 wt. %. B₂O₃ has the function of lowering melting temperature, viscosity at high temperature and density. However, when the amount of B₂O₃ increases, there is a matter of concern that defects may occur on the surface due to ion exchange.

In the present invention, the glass of the present invention is free of As₂O₃ or Sb₂O₃.

The glass of the present invention is free of TiO₂. Addition of TiO₂ will increase the crystallization tendency of the glass and the risks of devitrification during the process of 3D precision molding and thermal bending of the glass.

The transmittance of the glass is extremely important in display applications as a cover. Impurity elements may affect the transmittance of the glass after being chemical toughened. The reduction in transmittance is caused mainly by multi-valence ions such as Fe²⁺, Fe³. Therefore, the amounts of impurity elements must be lower than 500 ppm, preferably lower than 100 ppm, more preferably lower than 80 ppm, most preferably lower than 60 ppm.

The glass of the present invention can be refined using conventional refining technologies. The glass of the present invention may comprise a small amount of conventional refining agents. The sum of the added refining agents is preferably at most 2.0 wt. %, more preferably at most 1.0 wt. %. The sum of the amounts of the added refining agents and the amounts of the remaining components is 100 wt. %. The glass of the present invention may comprise at least one of the following components as a refining agent based on percentage by weight:

| CeO₂ | 0.01 to less than 0.2% |
|---|---|
| F₂ | 0-0.5% |
| SnO₂ | 0.01-0.5%. |

The glass of the present invention further comprises Yb₂O₃ in the following amount:

| component | wt. % |
|---|---|
| Yb₂O₃ | 0-0.5%, |

preferably:

| component | wt. % |
|---|---|
| Yb₂O₃ | 0-0.3%, |

particularly preferably:

| Component | wt. % |
|---|---|
| Yb₂O₃ | 0.01-0.3%. |

When the glass is subjected to thermal bending with an infrared radiation heater, in order to increase the absorption of infrared radiation by the glass, it can be achieved by doping the glass with Yb₂O₃ in an amount of 0-0.5 wt. %, preferably 0-0.3 wt. %, particularly preferably 0.01-0.3 wt %.

It is also important for thin glass to absorb infrared radiation, which can be achieved by doping the glass of the present invention with Yb₂O₃ in an amount of 0-0.5 wt. %, preferably 0-0.3 wt. %, particularly preferably 0.01-0.3 wt %. Addition of Yb³⁺ can increase laser absorption in infrared waveband, particularly having an absorption band at 970 nm, which reinforces the absorption of infrared light, and enhances the cutting efficiency. Adjusting of the amount of the doped Yb₂O₃ can increase the light absorption of the glass at wavelength greater than 600 nm. The absorption can be controlled in the range of 1%-20% according to the doping amount.

The glass of the present invention has a working point lower than 1200° C. (10⁴dPas), preferably lower than 1150° C. (10⁴dPas), more preferably lower than 1100° C. (10⁴dPas), most preferably lower than 1010° C. (10⁴dPas); and T_{g} lower than 610° C.; preferably the highest temperature of lower than 590° C., more preferably lower than 570° C., particularly lower than 550° C., and most preferably lower than 530° C.

In the present invention, the glass of the present invention has a CTE ranging from 7 to 12×10⁻⁶ 1/K.

In the present invention, the glass of the present invention has a depth of the layer of surface compressive stress, DoL, of 10-40 μm.

In the present invention, the glass of the present invention has a surface compressive stress of 600-1000 MPa.

In the present invention, the glass of the present invention can be produced through existing manufacture technologies, such as floating process, flow-through process, up-draw process, down-draw process.

The glass of the present invention can be cut with laser, and has a depth of the layer of surface compressive stress, DoL, of <40 μm, preferably <30 μm, more preferably <20 μm.

The glass of the present invention can be manufactured with a low production cost and an easy process. The glass of the present invention is applicable to 3D precision molding and thermal bending. The glass of the present invention has a low T_{g}, which prolongs the lifetime of moulds and refractory materials. And the glass of the present invention has an optimal amount of alkali metals, inhibiting evaporation of alkali metals during 3D molding or thermal bending, and extending the lifetime of recycling of moulds. And the optimized amount of alkali metals contributes to the optimized toughening properties of the glass, and therefore, the glass has optimized DoL and surface compressive stress, effecting a higher strength during toughening.

The process of forming a homogeneous glass bath free of gas bubbles (i.e., reducing gas bubbles, streaks, stones, etc. to the tolerable degree) and satisfying the molding requirements by heating a batch mixture at elevated temperature is called melting of the glass, which is an important step for production of the glass. The melting temperature of the glass is typically between 1300 and 1600° C. The glass is melted in a furnace made of refractory material. During melting of the glass, the refractory material and the glass melt interact with each other in elevated temperature so that the refractory material is damaged by erosion. The erosion speed of the glass bath on the refractory material mainly depends on the temperature of the glass bath. The erosion speed increases with temperature meeting a logarithmic relation. Increasing of the glass melting temperature means to increase the erosion of glass melt on the refractory material, therefore, greatly shortening the lifetime of refractory materials. An increase by 50-60° C. in melting temperature in the tank furnace will shorten the lifetime of refectory materials by about 50%. Therefore, lowering the glass melting temperature can prolong the lifetime of the tank furnace and increase productivity.

Molding of glass is a process of converting the melted glass to articles having fixed geometric shapes. The glass can be shaped only within a certain temperature range. Molding of the glass is related to the viscosity and temperature of the glass melt. The term “working point” is defined to denote the molding range of temperature for the glass. The so-called “working point” refers to the temperature corresponding to the viscosity of 10⁴ dPas. At this point, the glass is sufficiently soft to be molded in the glass molding process, such as blowing or pressing. The lower the temperature at the viscosity of 10⁴ dPas is, the easier the molding operation is, which therefore, reduces the cost of glass molding. The viscosity of the glass is related to the compositions of the glass, varying the components can change the viscosity of the glass as well as the temperature gradient of the viscosity to a viscosity suitable for molding.

The 3D precision molding process used for the glass of the present invention includes all conventional thermal molding processes: direct thermal pressing and secondary molding, and the combination of the two processes. One glass article for 3D precision molding or thermal bending is obtained directly from melting glass, i.e., after being melted, the melted glass is injected directly into the 3D precision molding mold or thermal bending mold, and then subjected to 3D precision molding or thermal bending. Another is that after glass is melted, the glass having corresponding sizes can be obtained from glass melt by floating process, up-draw process, down-draw process and flow-through process, and then said glass is made into blocks, strips, plates or sheets, afterwards, the thus obtained glass having certain shapes can be further processed with any processing technology of glass, such as conventional cutting and grinding, to obtain the glass having certain sizes and shapes suitable for 3D precision molding or thermal bending, and further the glass obtained above is subjected to the 3D precision molding and thermal bending.

Typically, the molding temperature for precision molding is from 650 to 700° C. Therefore, the glass having a glass transition temperature lower than 610° C. is favorable for precision molding. Molding process comprises steps of: disposing raw glass sheet in a base mold, vacuuming the mold chamber and filling with nitrogen or other inert gases, heating the base mold and the raw glass sheet, applying pressure with a pressing mold, molding, cooling, and taking out the pressed glass. The glass of the present invention has a glass transition temperature of lower than 610° C., preferably lower than 600° C., more preferably lower than 590° C., further preferably lower than 570° C., more further preferably lower than 550° C., particularly preferably lower than 530° C. The lower the glass transition temperature, the longer the lifetime of the mould and the higher the profitability of production. Therefore, the alkali aluminosilicate glass having a lower T_{g} is very important to manufacture by 3D molding.

The thermal bending temperature is typically lower than 800° C., preferably lower than 750° C., more preferably lower than 700° C., further preferably lower than 650° C., particularly lower than 600° C.

When the glass is subjected to thermal bending, the glass will deform rapidly under the action of self-gravity when the temperature of the glass is higher than its transition temperature (the glass then has a viscosity of about 10¹² Pa·s), especially at a viscosity of lower than 10⁹ Pa·s. When no support is present at the bottom of the glass, the glass will deform until each part on the surface of the glass contacts the surface of the support, or bend along the edge of the support till the surface is perpendicular to the ground. The thermal bending can be used to produce a glass cover plate having a 2D or 3D shape by producing molds of different shapes as the support. The thermal bending is used for glass molding that can be partially facilitated by pressure or vacuum, or infrared technology can be used to heat for thermal bending.

The 3D precision molding and the thermal bending can be combined for use in the present invention.

Both the 3D precision molding and the thermal bending are normally carried out at a temperature of from 650° C. to 950° C., which means that the glass should maintain stability in a re-heating process of treatment at a temperature of 650-950° C. without devitrification phenomenon occurring.

The inorganic non metal glass is defined as a solid not forming a crystal after the molten liquid is cured by supercooling, and therefore, the glass can also be regarded as a solid having a liquid structure. A common liquid may become unstable after being cooled to below the curing temperature and crystals may occur easily. However, the liquid that can form glass readily cannot crystallize yet under supercooling state due to increased viscosity during temperature lowering, and finally cool and solidify to non-crystallized glass. Glass is defined, by the United States National Research Council, as a solid presenting amorphous phase under X-ray, wherein the constituting atoms or molecules are in random distribution, and do not have a long-range ordering structure but may possess a short-range regularity. In view of thermodynamics, when a crystal is heated, its internal energy increases and its symmetry improves. When achieving the melting point, the crystal will melt to liquid and its viscosity will increase quickly when the temperature goes down. However, if the viscosity is too large, the constituting atoms of the glass do not have sufficient dynamic energy to reconstruct a crystal structure, and therefore, the glass not having a long-range order structure is formed. If the glass is re-heated, part of it will recrystallize, which is named as “devitrification” phenomenon. It is utmost important to ensure that the glass does not undergo devitrification during 3D precision molding and thermal bending. If the glass undergoes devitrification during 3D precision molding and thermal bending, the quality of the product will deteriorate. The glass normally needs to be placed in a mold and is molded for a few seconds to several minutes within a processing temperature range for 3D precision molding and thermal bending, and therefore, the glass should be kept stable and no devitrification should occur in the time range of a few seconds to several minutes within a molding temperature range for 3D precision molding and thermal bending.

The heating technologies for thermal bending can be conventional heating, and can also be infrared heating technology. The advantages of infrared heating technology include rapid rates of heating and cooling, thereby achieving higher energy efficiency and better process control.

Especially, the absorption of infrared radiation is very important to a thin glass. In order to increase the absorption of infrared radiation by the glass, the glass can be doped with Yb₂O₃ in an amount of 0-0.5 wt. %, preferably 0-0.3 wt. %. The absorption of light with a wavelength greater than 600 nm of the glass can be increased by adjusting the doping amount of Yb₂O₃. The absorption can be controlled between 1% and 20% depending on different doping amounts.

In addition, the glass of the present invention is applicable to laser cutting. The technology of laser cutting can achieve a lower cost in processing of cover plate and touch screen glass. Different laser cutting technologies, such as CO₂, UV, excimer laser, red or green lasers can be used. CO₂ infrared laser is widely used for glass cutting. One method is that the CO₂ infrared laser crosses the glass surface, most of the energy is absorbed by the glass surface, which has a depth of heat action of 50-100 μm. Immediately after laser heating, the glass surface is forcedly cooled in a quick manner, and then the glass generates tensile stress due to rapid thermal expansion and contraction. The glass cracks along the track across which the laser has passed starting from the pre-formed rupture due to tensile stress. When the pre-formed crack passes through the glass, the glass will be cracked completely along the rupture. Another method is that when the pre-formed rupture is relatively shallow, a scratch having a depth of 30-100 μm is formed on the glass surface, and then the glass is split manually. The “microscratch” laser glass cutting has an extremely high cutting rate. The laser glass cutting is advantageous over the traditional mechanical cutting in that high-quality edge of the glass, and no microcracks and broken edge; no limit on cutting shapes; no cutting scraps; no mechanical contact with the glass surface, and thus the glass surface being protected from being damaged. Besides CO₂ laser, UV laser can also be used to form various hollowed-out shapes, such as punching on the glass surface. UV laser has higher single-photon energy and can vaporize the glass directly and therefore, through holes are formed along the track across which the laser passes. However, the cutting speed of UV laser is very slow. Doping the glass with 0-0.5 wt. %, preferably 0-0.3 wt. %, particularly preferably 0.01-0.3 wt % of Yb₂O₃ can increase the absorption of infrared light by the glass. Therefore, it is more suitable to cut the glass with a laser having a wavelength greater than 632.8 nm.

After ion exchange, compressive stress is produced on the glass surface, and therefore, increasing the strength of the glass. For balancing the compressive stress on the glass surface, tensile stress will be formed on the center of the glass. The risks of the glass being broken will increase if the tensile stress is too high. A bent glass component is more sensitive to the central tensile stress under the influence of outside force. Therefore, the central tensile stress should be lower than 50 MPa, preferably lower than 30 MPa, more preferably lower than 20 MPa, most preferably lower than 15 MPa. And the surface compressive stress should be greater than 600 MPa, preferably greater than 700 MPa, most preferably greater than 800 MPa. The DoL (the depth of a layer of surface compressive stress) is 10-40 μm. A depth of DoL greater than 40 μm will cause an excessively high surface compressive stress and is not suitable to laser cutting accordingly. The cover plate glass should have a surface compressive stress of from 600 to 1000 MPa after chemical toughening and a surface compressive stress less than 600 MPa cannot achieve the desired strength.

The depth of a layer of surface compressive stress of the glass is in direct ratio to the square root of the time of chemical toughening. A proper thickness of a compressive stress layer helps increase the strength of the glass. The central tensile stress will increase with the compressive stress layer increasing. At the same time, stress relaxation will occur in glass networks under higher temperature for a long time, leading to reduction in compressive stress. Therefore, the strength of the glass is decreased instead of being increased if the time of chemical toughening is too long. On the other hand, an excessive period of time of chemical toughening will also increase the production cost. The present invention has a preferable chemical toughening time of <10 hours, more preferably <8 hours, further preferably <6 hours, and most preferably <4 hours.

For the glass of which the strength needs increasing through toughening, values of the depth of DoL and the surface compressive stress are critical. Values of the DoL and the surface stress are related to glass components, particularly the amounts of Li₂O, Na₂O and K₂O in the glass. An optimized match between the DoL and the surface compressive stress can be achieved by use of the mixed alkali effects and comprehensive adjustment of the relations between the components and the DoL as well as the surface compressive stress, i.e., the DoL is neither too deep nor too shallow, and the surface compressive stress is neither too large nor too small. When the glass is subjected to chemical toughening, if Na₂O/(Li₂O+Na₂O+K₂O) is too high, the desired depth, DoL, cannot be obtained as is required under the desired strength, and the surface compressive stress will be too small. If Na₂O/(Li₂O+Na₂O+K₂O) is too low, the depth, DoL, will be too deep, and the strength of the glass after being toughened will be reduced. However, it is not advisable to increase the thickness of the surface stress layer as much as possible since the central tensile stress will be increased, too.

The thickness of the surface stress layer reflects scratch tolerance of the toughened glass, i.e., surface hardness of the glass. The larger the surface stress layer is, the higher the stretch tolerance of the glass is, the less the glass surface is scratched easily. The property is characterized by hardness of the glass. For the purpose of increasing scratch resistance property of the glass, the glass should have a hardness (Knoop hardness) of higher 600 Kgf/mm², preferably higher than 670 Kgf/mm², more preferably higher than 700 Kgf/mm².

The glass is expected normally not only to have properties for precision molding, but also to have properties that quality of the glass surface is not lowered remarkably after being molded. The viscosity and thermal shock resistance of the glass should meet the requirements for a quick molding process, especially when pressing glass sheets less than 3 mm, preferably less than 2 mm, more preferably less than 1 mm.

The glass of the present invention is environmental friendly and is free of As₂O₃ and Sb₂O₃.

The glass of the present invention comprises 0-0.5 wt. %, preferably 0-0.3 wt. %, particularly preferably 0.01-0.3 wt % of Yb₂O₃. Adding Yb³⁺ can increase the absorption of infrared light, and the absorption of infrared radiation by the glass will in turn improve the processing efficiency of precision molding and thermal bending when an infrared radiation heater is used for a thermal bending process. The absorption of laser within the infrared band can be enhanced with an improvement to the efficiency of laser cutting.

The glass of the present invention is applicable to a cover plate, such as personal digital assistants, portable or cellular cells, watches, laptops and notebook PCs, digital cameras, PDAs, or as a substrate glass of touch panels. The glass of the present invention is also applicable to the application for electronic substrates, such as hard disks. The glass of the present invention has high impact property and high hardness. The glass of the present invention is suitable to be ion exchanged through chemical toughening.

### EXAMPLES

Table 1 includes the examples of embodiments within the preferable component ranges, and the glass of the present invention described in the examples is prepared as following.

Raw materials used are oxides, hydroxides, carbonates and nitrates, etc. (all purchased from Sinopharm Chemical Reagent Co., Ltd, Suzhou, Chemical Grade). After being weighed and mixed, the mixture is placed in a platinum crucible, melted in an electrical oven under a temperature of 1550-1600° C., refined at temperature of 1630-1650° C., then cast in a metal mold preheated to a suitable temperature, and the glass and the metal mold are placed in an annealing oven for annealing and cooling to obtain a glass preform.

In the present invention, the transition temperature, T_{g}, and the coefficient of thermal expansion, CTE, are tested on NETZSCH thermal dilatometer (NETZSCH DIL402PC). The strip test samples of about 50 mm are made from a glass specimen, and the temperature is elevated starting from room temperature at a rate of 5° C./min. till the end of experiment.

According to ASTM C-965 standard, the temperature of the working point (10⁴dPas) is tested on a high temperature rotary viscometer.

The glass density is measured based on the principle of Archimedes. A glass specimen is put into a container containing water, and the volume change in water is accurately measured to obtain the volume of the specimen. The weight of the specimen that can be measured accurately is divided by its volume to obtain the density data.

The glass devitrification test is carried out in a Muffle furnace. The glass is made into cubes of 5×5×5 cm, which are further subjected to surface polishing. After being heated in the Muffle furnace for 20 min., the sample is taken out to observe whether devitrification occurs under an optical microscope. X indicates no devitrification while 0 indicates that the glass has devitrified. The experiment is carried out at temperatures of 800° C. and 900° C.

The specimen is subjected to chemical toughening. A lab-scale small-sized salt bath furnace (having a diameter of 250×250 mm, and a depth of 400 mm) is used for toughening. The specimen is placed on an anticorrosion stainless steel sample holder; and undergoes 4-8 hours ion exchange treatment at 370-480° C. in a KNO_{B} salt bath.

The stress and the depth of the stress layer of the glass are measured on FSM6000 and polarizing microscope.

Table 1 shows the components expressed as wt %, densities, CTE, T_{g} and working point (10⁴dPas) of examples 1-8 of the glass.

TABLE 1

| | examples | | | | | | |
|---|---|---|---|---|---|---|---|
| | 1 | 2 | 3 | 4 | 5 | 6 | 7 |
| components | wt % | | | | | | |
| SiO₂ | 55.8 | 60.8 | 52.8 | 60.2 | 51 | 62 | 61 |
| Al₂O₃ | 15 | 12.5 | 13 | 13 | 17 | 5 | 7 |
| Na₂O | 9 | 11.5 | 12 | 11 | 12 | 15 | 13 |
| K₂O | 3 | 2.5 | 4 | 3 | 4 | 5.2 | 4.8 |
| MgO | 9 | 7 | 6.2 | 7 | 3.8 | 6.2 | 6.5 |
| CaO | 5 | 4.3 | 4.1 | 2 | 6 | 5.8 | 5 |
| ZrO₂ | 0.8 | 0.5 | 1 | 0.5 | 1.5 | 0.5 | 0.4 |
| SrO | | 0.7 | | 1 | | | |
| CeO₂ | 0.05 | | 0.1 | 0.2 | 0.1 | 0.1 | 0.1 |
| F₂ | 0.05 | 0.05 | 0.1 | 0.1 | 0.1 | 0.1 | 0.1 |
| SnO₂ | 0.1 | 0.15 | 0.2 | | 0.1 | 0.1 | 0.1 |
| B₂O₃ | | | | | | | |
| Li₂O | 2.0 | | 3.0 | | | | |
| ZnO | | | 3.5 | 2 | 3.4 | | 2 |
| BaO | | | | | 1 | | |
| Yb₂O₃ | 0.2 | | | | | | |
| SiO₂ + Al₂O₃ | 70.8 | 73.3 | 65.8 | 73.2 | 68 | 67 | 68 |
| CaO + MgO | 14 | 11.3 | 10.3 | 9 | 9.8 | 12 | 11.5 |
| Na₂O/(Li₂O + Na₂O + K₂O) | 0.64 | 0.82 | 0.63 | 0.79 | 0.75 | 0.74 | 0.73 |
| density | 2.58 | 2.54 | 2.61 | 2.57 | 2.63 | 2.54 | 2.52 |
| working point | 1090 | | | 1050 | | 997 | |
| temperature (° C.) | | | | | | | |
| (10⁴ dPas) | | | | | | | |
| Tg (° C.) | 558 | 609 | 492 | 512 | 556 | 525 | 547 |
| CTE 10⁻⁶/K (25-300° C.) | 8.8 | 8 | 10.1 | 9.4 | 9.7 | 10.8 | 9.9 |
| AT (yield point) ° C. | 631 | 696 | 559 | 580 | 635 | 597 | 623 |
| Heating temperature | X | X | X | | X | | |
| 800° C. | | | | | | | |
| Heating temperature | ◯ | | ◯ | | ◯ | | |
| 900° C. | | | | | | | |
| thickness (mm) | 0.5 | 1.1 | 0.7 | 1.5 | 1.1 | 0.7 | 0.7 |
| ion exchange | 440° C. | 440° C. | 460° C. | 460° C. | 440° C. | 420° C. | 420° C. |
| temperature (° C.) | | | | | | | |
| ion exchange time (hour) | 8 | 6 | 4 | 8 | 6 | 4 | 8 |
| ion exchange depth (μm) | 12 | 21 | 12 | 9 | 16 | 16 | 20 |
| surface stress (MPa) | 860 | 800 | 620 | 610 | 980 | 630 | 680 |
| central tensile stress | 22 | 16 | 11 | 4 | 15 | 15 | 21 |
| (MPa) | | | | | | | |

TABLE 2
Comparative Examples

| component | 1 | 2 | 3 | 4 |
|---|---|---|---|---|
| SiO₂ (wt. %) | 44.5 | 54.8 | 73 | 62.6 |
| Al₂O₃ (wt. %) | 45.1 | 11.0 | 0.27 | 16.55 |
| B₂O₃ (wt. %) | | | | |
| P₂O₅ (wt. %) | 3 | | | |
| Li₂O (wt. %) | 0.7 | | | |
| Na₂O (wt. %) | 0.4 | 3.0 | 14 | 12.9 |
| K₂O (wt. %) | 0.2 | 10.85 | 0.03 | 3.5 |
| MgO (wt. %) | 0.5 | | 4 | 3.3 |
| CaO (wt. %) | | | 9 | 0.3 |
| SrO(wt. %) | | 11.2 | | |
| BaO(wt. %) | | 4.65 | | |
| ZnO (wt. %) | 0.7 | | | |
| CeO₂ (wt. %) | | | | |
| TiO₂ (wt. %) | | | | 0.8 |
| ZrO₂ (wt. %) | 2.8 | 4.5 | | |
| SnO₂ (wt. %) | 2.1 | | | 0.05 |
| SiO₂ + Al₂O₃ | 89.6 | | 73.27 | 79.15 |
| CaO + MgO | 0.5 | | 13 | 3.6 |
| Na₂O/(Li₂O + Na₂O + K₂O) | 0.31 | | 1 | 0.79 |
| thickness(mm) | | 0.7 | 1.0 | 0.5 |
| density(g/cm³) | 2.41 | | 2.50 | 2.43 |
| T_{g}(° C.) | 645 | 626 | 560 | 623 |
| working point | 1307 | 1253 | | |
| temperature(10⁴ dPas) | | | | |
| CTE(10⁻⁶/K) | | | | 8.33 |
| ion exchange | 400 | 440 | 420 | 420 |
| temperature(° C.) | | | | |
| ion exchange time (hour) | 8 | 6 | 8 | 8 |
| ion exchange depth(μm) | | 8 | 12 | 36 |
| surface compressive | | 550 | 450 | 750 |
| stress of (MPa) | | | | |
| Central tensile | | 6 | 6 | 63 |
| stress (MPa) | | | | |

### Example 2

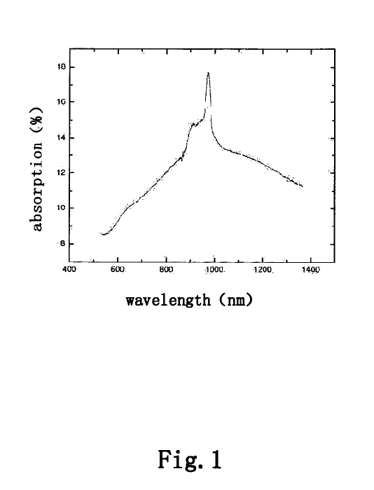

FIG. 1 is the absorption spectrum of the glass doped with Yb₂O₃. The absorption of the glass is greater than 8% at a wavelength range greater than 600 nm.

1-29. (canceled)

30. An alkali aluminosilicate glass for 3D precision molding and thermal bending, said glass comprising, based on the sum of all the components,
Si0₂ 51 to 63 weight percent;
Al₂0₃ 5 to 18 weight percent;
Na₂0 8 to 16 weight percent;
K₂0 0 to 6 weight percent;
MgO 3.5 to 10 weight percent;
B₂0₃ 0 to 5 weight percent;
Li2O 0 to 4.5 weight percent;
ZnO 0 to 5 weight percent;
CaO 0 to 8 weight percent;
Zr0₂ 0.1 to 2.5 weight percent;
Ce0₂ 0.01 to less than 0.2 weight percent;
F₂ 0 to 0.5 weight percent;
Sn0₂ 0.01 to 0.5 weight percent;
BaO 0 to 3 weight percent;
SrO 0 to 3 weight percent;
Yb₂0₃ 0 to 0.5 weight percent;
ΣSi0₂+Al₂0₃ 63 to 81 weight percent;
ΣCaO+MgO 3.5 to 18 weight percent; and
Na₂0/(Li₂O+Na₂0+K₂0) 0.4 to 1.5 weight percent.

31. The alkali aluminosilicate glass according to claim 30, wherein said glass comprises:
Si0₂ 53 to 62 weight percent;
Al₂0₃ 5 to 17 weight percent;
Na₂0 9 to 15 weight percent;
K₂0 2 to 5 weight percent;
MgO more than 6 and less than or equal to 9 weight percent;
B₂0₃ 0 to 3 weight percent;
Li2O 0 to 4 weight percent;
ZnO 0 to 5 weight percent;
CaO more than 4 and less than or equal to 7 weight percent
Zr0₂ 0.5 to 1.8 weight percent;
Ce0₂ 0.01 to less than 0.2 weight percent;
F₂ 0.1 to 0.5 weight percent;
Sn0₂ 0.01 to 0.5 weight percent;
BaO 0 to 2 weight percent;
SrO 0 to 2 weight percent;
Yb₂0₃ 0 to 0.5 weight percent;
ΣSi0₂+Al₂0₃ 66 to 79 weight percent;
ΣCaO+MgO greater than 10 to 18 weight percent; and
Na₂0/(Li₂O+Na₂0+K₂0) 0.5 to 1.0 weight percent.

32. The alkali aluminosilicate glass according to claim 30, wherein said glass comprises:
Si0₂ 53 to 62 weight percent;
Al₂0₃ 13 to 17 weight percent;
Na₂0 9 to 13 weight percent;
K₂0 2 to 5 weight percent;
MgO more than 6 and less than or equal to 9 weight percent;
B₂0₃ 0 to 3 weight percent;
Li2O 0 to 3.5 weight percent;
ZnO 0 to 5 weight percent;
CaO more than 4 and less than or equal to 7 weight percent
Zr0₂ 0.5 to 1.8 weight percent;
Ce0₂ 0.01 to less than 0.2 weight percent;
F₂ 0.1 to 0.5 weight percent;
Sn0₂ 0.01 to 0.5 weight percent;
BaO 0 to 2 weight percent;
SrO 0 to 2 weight percent;
Yb₂0₃ 0 to 0.3 weight percent;
ΣSi0₂+Al₂0₃ 66 to 79 weight percent;
ΣCaO+MgO greater than 10 to 18 weight percent; and
Na₂0/(Li₂O+Na₂0+K₂0) 0.55 to 0.9 weight percent.

33. The alkali aluminosilicate glass according to claim 30, wherein said glass has a working point of lower than 1200° C. (104 dPas).

34. The alkali aluminosilicate glass according to claim 30, wherein said glass has a working point of lower than 1150° C. (104dPas).

35. The alkali aluminosilicate glass according to claim 30, wherein said glass has a working point of lower than 1100° C. (104 dPas).

36. The alkali aluminosilicate glass according to claim 30, wherein said glass has a glass transition temperature of lower than 610° C.

37. The alkali aluminosilicate glass according to claim 30, wherein said glass has a glass transition temperature of lower than 570° C.

38. The alkali aluminosilicate glass according to claim 30, wherein said glass has a glass transition temperature of lower than 530° C.

39. The alkali aluminosilicate glass according to claim 30, wherein said glass has a coefficient of thermal expansion in the range of 7−12×10⁻⁶/K.

40. The alkali aluminosilicate glass according to claim 30, wherein the amount of Yb₂0₃ is 0.01 to 0.3 weight percent.

41. The alkali aluminosilicate glass according to claim 30, wherein said glass is free of As₂0₃ or Sb₂0₃.

42. The alkali aluminosilicate glass according to claim 30, wherein said glass has a depth of layer of surface compressive stress of 10 to 40 μm.

43. The alkali aluminosilicate glass according to claim 30, wherein said glass has a surface compressive stress of 600 to 1000 MPa.

44. The alkali aluminosilicate glass according to claim 30, wherein said glass has a toughening time of less than 10 hours.

45. The alkali aluminosilicate glass according to claim 30, wherein said glass has a toughening time of less than 4 hours.

46. The alkali aluminosilicate glass according to claim 30, wherein said glass has a hardness greater than 600 Kgf/mm².

47. The alkali aluminosilicate glass according to claim 30, wherein said glass has a hardness greater than 700 Kgf/mm².

48. The alkali aluminosilicate glass according to claim 47, wherein said glass has an infrared absorption of 1% to 20% at a wavelength greater than 600 nm.

49. A glass article made, comprising an alkali aluminosilicate glass, based on the sum of all the components, having:
Si0₂ 51 to 63 weight percent;
Al₂0₃ 5 to 18 weight percent;
Na₂0 8 to 16 weight percent;
K₂0 0 to 6 weight percent;
MgO 3.5 to 10 weight percent;
B₂0₃ 0 to 5 weight percent;
Li2O 0 to 4.5 weight percent;
ZnO 0 to 5 weight percent;
CaO 0 to 8 weight percent;
Zr0₂ 0.1 to 2.5 weight percent;
Ce0₂ 0.01 to less than 0.2 weight percent;
F₂ 0 to 0.5 weight percent;
Sn0₂ 0.01 to 0.5 weight percent;
BaO 0 to 3 weight percent;
SrO 0 to 3 weight percent;
Yb₂0₃ 0 to 0.5 weight percent;
ΣSi0₂+Al₂0₃ 63 to 81 weight percent;
ΣCaO+MgO 3.5 to 18 weight percent; and
Na₂0/(Li₂O+Na₂0+K₂0) 0.4 to 1.5 weight percent.

50. The glass article according to claim 49, wherein said glass can has a laser cut and a depth of layer surface compressive stress of less than 40 μm.

51. The glass article according to claim 49, further comprising a thermal bend achieved through infrared heating.

52. The glass article according to claim 49, wherein said article is suitable for use as a cover plate or a back plate for a portable electronic device, a handheld device, or a laptop.

53. The glass article according to claim 49, wherein said article comprises a glass preform.

54. The glass article according to claim 49, wherein said article comprises an optical component.
